(19) United States
(12) Patent Application Publication
(10) Pub. No.: US 2009/0002670 A1
(43) Pub. Date: Jan. 1, 2009

(54) Apparatus for the manipulation and/or adjustment of an optical element

(75) Inventors: Frank Melzer, Utzmemmingen (DE); Markus Weiss, Aalen (DE); Guenther Dengel, Heidenheim (DE); Volker Stein, Buseck (DE)

Correspondence Address: Gerald T. Shekleton, 22nd Floor, 120 South Riverside Plaza, Chicago, IL, 60606, US

(73) Assignee: CARL ZEISS SMT AG, Oberkochen (DE)

(21) Appl. No.: 12/221,045

(22) Filed: Jul. 30, 2008

Related U.S. Application Data
(63) Continuation of application No. 11/366,880, filed on Mar. 2, 2006, now abandoned.
(60) Provisional application No. 60/658,733, filed on Mar. 4, 2005.

(51) Int. Cl. G03B 27/54

(52) U.S. Cl. 355/67

(57) ABSTRACT

The invention relates to an apparatus for the manipulation and/or adjustment of an optical element with respect to a structure, the optical element being connected to the structure by means of a number of setting members, and the setting members having as active adjusting elements screw elements or piezoceramic elements, which in each case produce an active force along one degree of freedom and by means of which the optical element is connected to the structure in such a way that it can be set in up to six degrees of freedom.

This application is a continuation of U.S. Utility application Ser. No. 11/366,880, filed Mar. 2, 2006 which was in turn based on U.S. Provisional Application No. 60/658,733, filed Mar. 4, 2005.

### BACKGROUND OF THE INVENTION

1. Field of the Invention

The invention relates to an apparatus for the manipulation and/or adjustment of an optical element with respect to a structure, an illuminating system, a projection exposure machine and a method for producing semiconductor components.

2. Description of the Prior Art

An apparatus for the manipulation of an optical element in up to six degrees of freedom with respect to a structure is known from EP 1 312 965 A1.

Optical elements, in particular mirrors, are mainly manipulated or adjusted in three degrees of freedom, using piezo actuators for example for this purpose. U.S. Pat. No. 5,986,827 discloses a manipulation apparatus for an optical element in three degrees of freedom.

However, special applications, for instance the exact positioning or adjustment of optical elements, optical components, optical assemblies or a wafer table in projection exposure machines, in particular in the area of EUVL, require manipulating or positioning operations in up to six degrees of freedom (both x, y, z translation and rotation about these axes) with at the same time high accuracies.

### SUMMARY OF THE INVENTION

The present invention is based on the object of providing an apparatus of the type mentioned at the beginning which permits reproducible and precise manipulation and/or adjustment of optical elements or components or assemblies in up to six degrees of freedom.

This object is achieved according to the invention by an apparatus for the manipulation and/or adjustment of an optical element with respect to a structure, the optical element being connected to the structure by means of a number of setting members, and the setting members having as active adjusting elements screw elements or piezoceramic elements, which in each case produce an active force along one degree of freedom and by means of which the optical element is connected to the structure in such a way that it can be set in up to six degrees of freedom.

An alternative solution to achieve the object is provided by an apparatus for the manipulation and/or adjustment of an optical element with respect to a structure, the optical element being connected to the structure by means of a number of setting members, and the setting members having as passive adjusting elements tuning washers respectively disks adapted to the required setting, by means of which the optical element is connected to the structure in such a way that it can be set in up to six degrees of freedom.

The measures according to the invention provide a precise, reproducible and simple possibility for the adjustment or manipulation of optical elements, assemblies or components in up to six degrees of freedom. Differential thread screws or piezo actuators may be used as active adjusting elements. Furthermore, simple screws are also conceivable. Provided as passive actuating elements are tuning disks, which are adapted to the required setting. The adjusting elements to be used depend substantially on the required adjusting or positioning accuracy of the optical component.

According to the invention, it may also be provided that screw elements and piezoceramic elements or passive adjusting elements, in particular tuning disks, are provided in a combined manner.

A combination of the adjusting elements is likewise possible, such as for example differential thread screws for greater adjusting displacements and piezo actuators for the corresponding fine positioning. In addition, a rough pre-adjustment of actuator devices or Lorenz actuators, as are known in particular from U.S. 60/502,334 and PCT/EP2004/009941, which are not prior publications, is also possible.

In a particularly advantageous refinement of the invention, it may also be provided that three setting members are provided, which in each case have two active or passive adjusting elements, the two active or passive adjusting elements in each case being arranged at an angle of about 60° to about 120°, preferably about 90°, in relation to one another and the setting members being arranged substantially at uniform intervals, preferably at three intervals of about 120°, around the optical element or around a supporting structure or mount or holder of the optical element.

By means of these measures, the optical element or the optical component or assembly is advantageously mounted in a statically defined manner in an arrangement which permits a precise manipulation, adjustment or positioning in up to six degrees of freedom.

An illuminating system, in which at least one optical element is mounted in such a way that it can be manipulated by means of an apparatus according to the invention, is specified in claim 19.

Claim 20 relates to a projection exposure machine with an illuminating system according to claim 19 and with a projection lens. Claim 21 provides a method for producing semiconductor components using a projection exposure machine of this type.

Further advantageous refinements and developments of the invention are provided by the remaining subclaims.

Therefore there is disclosed an apparatus for the manipulation of an optical element with respect to structure, the optical element being connected to the structure by means of a number of setting members, and the setting members comprising as active adjusting elements screw elements or piezoceramic elements, which in each case produce an active force along one degree of freedom and by means of which the optical element is connected to the structure with up to six degrees of freedom. Further, the manipulation of the optical element comprises an adjustment of the optical element. The screw elements referred to above may be differential thread screws. The invention may also include devices that comprise restoring forces for adjustment by means of said differential thread screws, which may comprise joints by means of which they are connected to the optical element or a supporting structure of the optical element such joints may be cardanic solid-state joints. The differential thread screws may also comprise thrust pieces as a bearing support for a supporting structure of the optical element and additionally have electrical drive elements. The electrical drive elements may comprise piezoceramic elements. The subject invention further includes three setting members with in each case two active adjusting elements said two active adjusting elements in each case being arranged at an angle of about 60° to about 120°, around the optical element or around the supporting structure of the optical element.

The method of the subject invention for producing semiconductor components may also use a projection exposure machine.

Further, the subject invention includes a projection exposure machine with an illuminating system having a projection lens for microlithography for the production of semiconductor components.

Further, the subject invention includes a method for producing semiconductor components using a projection exposure machine.

### BRIEF DESCRIPTION OF THE DRAWINGS

Several exemplary embodiments of the invention are presented in principle below on the basis of the drawing, in which:

FIG. 1 shows a basic construction of an EUV projection exposure machine with a light source, an illuminating system and a projection lens;

FIG. 2 shows a perspective view of an apparatus according to the invention for mounting a mirror;

FIG. 3 shows a basic representation of a setting member of the apparatus according to the invention from FIG. 2;

FIG. 4 shows a perspective representation of the apparatus according to the invention for mounting a mirror in a second embodiment;

FIG. 5 shows a perspective representation of the apparatus according to the invention from FIG. 4 without the mirror being used; and

FIG. 6 shows a basic sectional view through a differential thread screw as an adjusting element for the apparatus according to the invention as shown in FIGS. 4 and 5.

### DETAILED DESCRIPTION

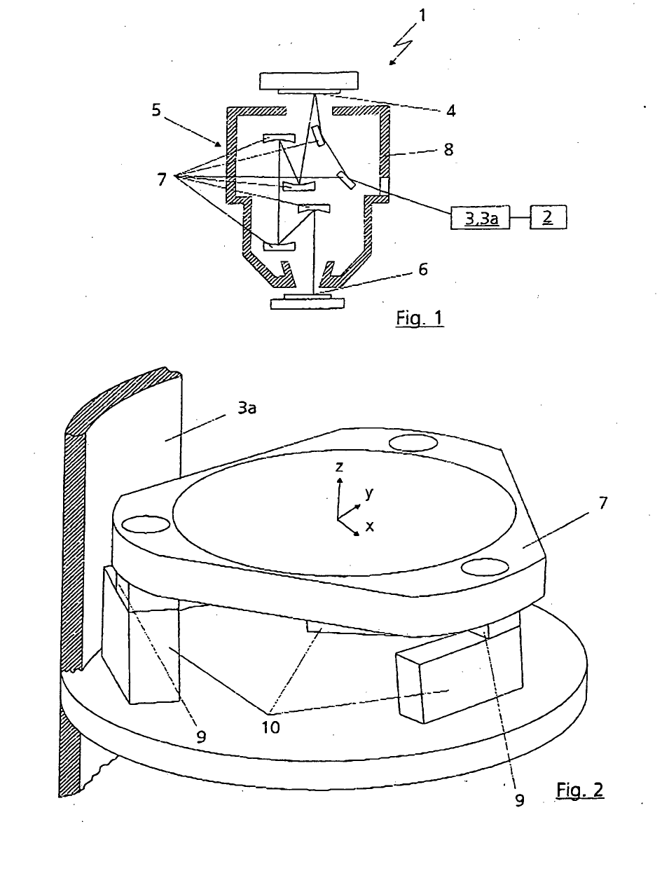

As can be seen from FIG. 1, an EUV projection exposure machine 1 has a light source 2, an EUV illuminating system 3 with a housing 3a for illuminating a field in a plane 4 in which a structured mask is arranged, and also a projection lens 5 for projecting an image of the structured mask in the plane 4 onto a light-sensitive substrate 6. An EUV projection exposure machine 1 of this type is known from EP 1 278 089 A2.

In the illuminating system 3 it is also often necessary to provide a possibility for the manipulation and/or adjustment of optical elements, for instance of mirrors 7 or of optical assemblies or components (not represented) in relation to a housing 3a of the illuminating system 3. Appropriate links with setting members or actuator devices 9 of the mirrors 7 with respect to the housing 3a of the illuminating system 3 are provided for this purpose (see in this respect FIGS. 2, 4 and 5 in particular). In another exemplary embodiment, the optical elements could also be manipulated or adjusted in relation to the housing 8, a sensor frame or a measuring structure of the projection lens 5. A measuring structure of this type is known for example from DE 101 34 387 A1.

FIG. 2 shows a simplified perspective view of an apparatus according to the invention for the manipulation and/or adjustment of the mirror 7 with respect to the housing 3a of the illuminating system 3, the mirror 7 being connected to the housing 3a as a structure by means of a supporting structure, formed as a mirror holder 9, and three setting members 10.

As can further be seen from FIG. 2, the setting members 10 are arranged uniformly at three intervals of 120° around the mirror 7.

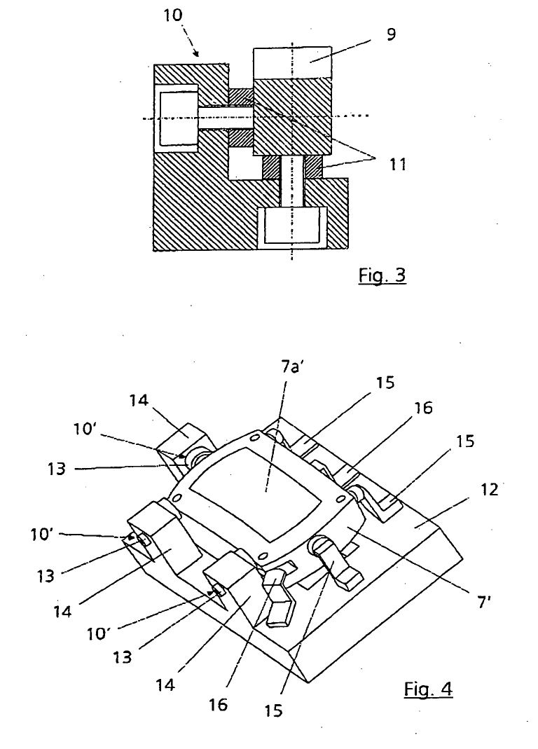

As can be seen from FIG. 3, the setting members 10 have in each case two tuning disks 11, adapted to the adjustment or setting, as passive adjusting elements. In a further exemplary embodiment, the tuning disks 11 may also be formed as piezoceramic disks. Consequently, in the case of the apparatus according to the invention for the manipulation and/or adjustment of the mirror 7 as shown in FIGS. 2 and 3, six tuning disks 11 are provided as adjusting elements, by means of which the mirror 7 is connected to the housing 3a in such a way that it can be set in up to six degrees of freedom. Two tuning disks 11 of a respective setting member 10 are arranged at an angle of about 90° in relation to one another. In further exemplary embodiments, the tuning disks 11 could also be arranged at other angles of about 60° to about 120° in relation to one another. In addition, the tuning disks 11 could also be replaced by active adjusting elements, such as differential thread screws, piezo shims, servo-controlled adjusting elements or the like. Similarly, a combination of the passive tuning disks 11 with active adjusting elements is also conceivable. In particular, in a further exemplary embodiment, a rough pre-adjustment of actuator devices or Lorenz actuators, which are known from U.S. 60/502,334 and PCT/EP2004/009941, which are not prior publications and the disclosure of which is hereby incorporated in full, is also possible with the passive tuning disks 11. After which a fine adjustment may take place.

In the present case, the tuning disks 11 are formed in such a way that the mirror 7 can be kept at a predetermined electric potential. For this purpose, the tuning disks 11 are formed from a nonconducting or electrically insulating material. This permits a targeted control, that is to say acceleration or deceleration, of the ions located in the vicinity of the mirror 7. In other exemplary embodiments, the tuning disks may also be formed in such a way that they are electrically conducting.

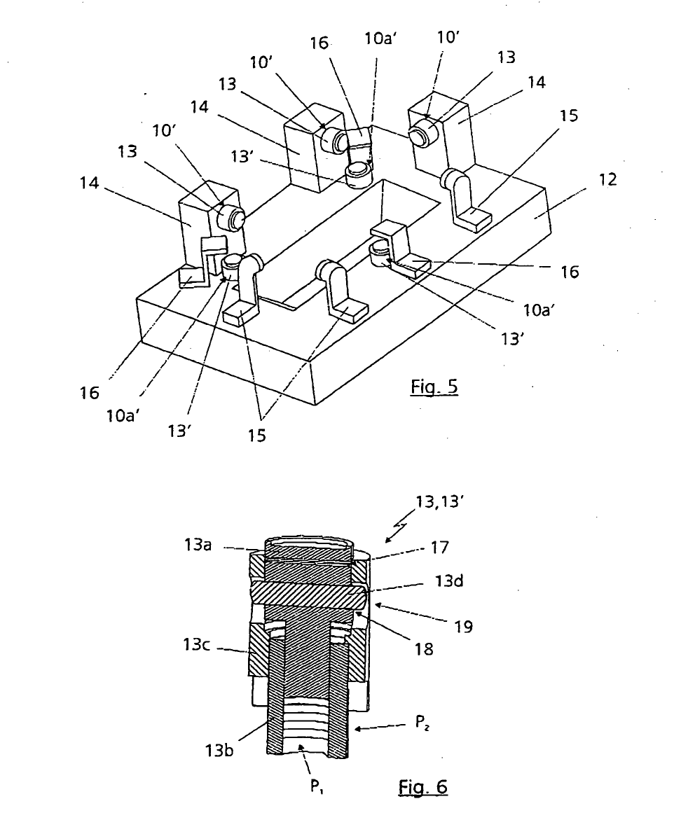

FIGS. 4 and 5 show an embodiment of an apparatus according to the invention for the manipulation and/or adjustment of a mirror 7′ with respect to a base plate 12, which is connected to the housing 3a (not represented). Setting members 10, 10a′ for the manipulation and/or adjustment of the mirror 7′ have differential thread screws 13, 13′ as active adjusting elements (with respect to the setting members 10a′ with the differential thread screws 13′, reference is made to FIG. 5). It is usually assumed that, for screw elements, a rotational resolution of approximately 10° can be achieved. In other words, 36 positions can be set for each revolution, whereby, for a simple screw, approximately 1/36 of the screw thread is obtained as the minimum resolution. In the case of differential thread screws 13, 13′, a minimum resolution of 1/36 can be achieved as the difference between the two thread pitches used. Here, a resolution of about 1 μm is realistic. If higher accuracies are required, or the system has to be actively operated, recirculating ball mechanisms, piezo drives or the like are used. The differential thread screws 13, 13′ may also be used in other exemplary embodiments for the rough pre-adjustment of actuator devices or Lorenz actuators, as are known from U.S. 60/502,334 and PCT/EP2004/009941, which are not prior publications.

The setting members 10′ are fitted in stop holders 14. Spring devices 15 arranged on the base plate 12 produce the required restoring forces for the adjustment by means of the differential thread screws 13 in the x and y directions. Spring devices 16 arranged on the base plate 12 produce the required restoring forces for the adjustment in the z direction. In FIG. 4, a system of coordinates which has its origin at the center of the mirror 7′ or the point of impingement of the main light beam is assumed. The z axis of this system of coordinates is perpendicular to the optically effective area 7a′ of the mirror 7′, the y axis is oriented along the shorter side of the mirror 7′ and the x axis is oriented along the longer side thereof.

FIG. 5 shows the same construction as FIG. 4, but without the mirror 7′ being used. A total of six setting members 10′, 10a′, which in each case have a differential thread screw 13, 13′, are provided. The three setting members 10a′ with the differential thread screw 13′ are directly incorporated in the base plate 12 and serve for the adjustment or setting in the z direction, and also for tilting settings about the x and y axes (rx and ry), whereby three degrees of freedom are already fixed. The spring devices 16 oppose the infeed movement of the differential screws 13′ and on the one hand produce the prestressing forces which bring about resting on the receiving surfaces of the differential screws 13′, on the other hand the required stiffness of the system can be set by the biasing of the spring devices 16. Here, a compromise between required prestressing and admissible compressive loading of the mirror material should be chosen. With the two further differential thread screws 13 of the setting members 10′ along the long side of the base plate 12, which are incorporated in the stop holders 14, a displacement of the mirror in the y direction and a turning about the z axis can be set, so that two further degrees of freedom can be set or are fixed. The last still remaining degree of freedom is set by means of the differential thread screw 13, which is incorporated on the short side of the base plate 2, likewise in a stop holder 14.

In FIG. 6, a basic section through a differential thread screw 13 or 13′ is represented. The differential thread screw 13, 13′ has a thrust piece 13a for bearing against the mirror 7′. The size of the bearing surface of the thrust piece 13a against the mirror 7′ should in this case be designed in such a way that the admissible compressive stress is not exceeded in the thrust piece 13a or in the mirror 7′. To make the requirements for production tolerances of optical and mechanical parts less demanding, the thrust piece 13a is provided in the upper region adjoining the supporting surface with a cardanic solid-state joint 17. In other words, the mirror 71 is connected to the differential thread screw 13, 13′ by means of the solid-state joint 17. As a result, the thrust piece 13a is brought to bear against the mirror 7′ with a contact surface that is as large as possible. On the side of the thrust piece 13a that is facing away from the mirror surface, a thread with a pitch p1 is provided on the outside. The thrust piece 13a is screwed into an adjusting sleeve 13b, which has an internal thread with a pitch p1. A further thread with a pitch p2 is provided on the outer circumference of the adjusting sleeve 13b. The unit comprising the thrust piece 13a with the adjusting sleeve 13b is then screwed as a whole into a housing 13c of the differential thread screw 13, 13′ until a locating bore hole 18 of the thrust piece 13a is level with a long recess 19 of the housing 13c. The housing 13c likewise has an internal thread with the pitch p2. Subsequently, the thrust piece 13a is secured against twisting by a locating pin 13d. If the adjusting sleeve 13b is then turned, it is screwed with the thread pitch p2 into the housing 13c. Relative to this, however, the thrust piece 13a is screwed with the thread pitch p1 into the adjusting sleeve 13b. This produces a differential movement between the housing 13c and the thrust piece 13a of Δp=p2−p1. If p2>p1 is chosen, and consequently Δp>0, an infeed movement takes place in the accustomed way when the adjusting sleeve 13b is turned to the right. With customary fine threads, such as for instance 0.3 mm and 0.35 mm, differential thread screws with 50 μm per revolution can consequently be easily produced.

In a simple and advantageous way, it is then possible with the embodiment of the apparatus for the manipulation and/or adjustment of the mirror 7′ to ensure exact setting of the mirror 71 in six degrees of freedom. In further exemplary embodiments, the setting members 10′, 10a′ with the differential thread screws 13, 13′ can also be combined with other active adjusting elements, such as for example piezo actuators, or passive adjusting elements, such as for example tuning disks or the like, or be replaced by them. In addition, in further exemplary embodiments, the differential thread screws 13, 13′ could be provided with electrical drive elements, in particular piezoceramic elements (not represented).

1. Apparatus for the manipulation of an optical element with respect to a structure, the optical element being connected to the structure by means of a number of setting members, and said setting members comprising as active adjusting elements screw elements or piezoceramic elements, which in each case produce an active force along one degree of freedom and by means of which the optical element is connected to the structure in such a way that it can be set in up to six degrees of freedom.

2. The Apparatus according to claim 1, wherein the manipulation of the optical element is used for an adjustment of the optical element.

3. Apparatus according to claim 1, wherein said screw elements and said piezoceramic elements are present in a combined manner.

4. Apparatus according to claim 1, further including passive adjusting elements, in particular tuning washers, are additionally provided.

5. Apparatus according to claim 1, wherein said screw elements are differential thread screws.

6. Apparatus according to claim 5, wherein spring devices are provided for the restoring forces for adjustment by means of said differential thread screws.

7. Apparatus according to claim 5, wherein said differential thread screws comprise joints by means of which they are connected to the optical element or a supporting structure of the optical element.

8. Apparatus according to claim 7, wherein said joints are cardanic solid-state joints.

9. Apparatus according to claim 5, wherein said differential thread screws comprise thrust pieces as a bearing support for the optical element or as a bearing support for a supporting structure of the optical element.

10. Apparatus according to claim 5, wherein said differential thread screws have electrical drive elements.

11. Apparatus according to claim 10, wherein said electrical drive elements comprise piezoceramic elements.

12. Apparatus according to claim 1, wherein three setting members with in each case two active adjusting elements are provided, said two active adjusting elements in each case being arranged at an angle of about 60° to about 120°, preferably about 90°, in relation to one another.

13. Apparatus according to claim 1, wherein said setting members are arranged substantially at uniform intervals, preferably at 3 intervals of about 120°, around the optical element or around a supporting structure of the optical element.

14. An apparatus for the manipulation of an optical element with respect to a structure, the optical element being connected to the structure by means of a number of setting members, and said setting members comprising as passive adjusting elements, tuning washers adapted to the required setting by means of which the optical element is connected to the structure in such a way that it can be set in up to six degrees of freedom, wherein the structure is a part of an EUV projection exposure machine.

15. The apparatus according to claim 14, wherein the manipulation of the optical element is used for an adjustment of the optical element.

16. The apparatus according to claim 14, wherein said tuning washers are formed from an electrically insulating material.

17. The apparatus according to claim 14, wherein said tuning washers and active adjusting elements, in particular screw elements or piezoceramic elements, are provided in a combined manner.

18. The apparatus according to claim 14, wherein said tuning washers are piezoceramic washers.

19. The apparatus according to claim 14, wherein three setting members with in each case two passive adjusting elements are provided, said two passive adjusting elements in each case being arranged at an angle of about 60° to about 120°, preferably about 90°, in relation to each other.

20. The apparatus according to claim 14, wherein said setting members are arranged substantially at uniform intervals, preferably at 3 intervals of about 120°, around the optical element or around a supporting structure of the optical element.

21. Illuminating system, of a projection exposure machine for microlithography for the production of semiconductor components in EUV range, with a number of optical elements arranged in a housing, at least one of said optical elements being mounted in such a way that it can be manipulated and/or adjusted with respect to the housing as structure by means of an apparatus according to claim 14

22. Projection exposure machine with an illuminating system according to claim 21 and with a projection lens for microlithography for the production of semiconductor components.

23. Method for producing semiconductor components using a projection exposure machine according to claim 22.

24. The apparatus according to claim 14 wherein the structure is a part of an illuminating system of an EUV projection exposure machine for microlithography.
